(19) United States
(12) Patent Application Publication
(10) Pub. No.: US 2025/0124451 A1
(43) Pub. Date: Apr. 17, 2025

(54) SYSTEMS AND METHODS FOR VIRTUAL CERTIFICATION NUMBER GENERATION

(71) Applicant: Capital One Services, LLC, McLean, VA (US)

(72) Inventors: Joshua EDWARDS, Philadelphia, PA (US); Michael MOSSOBA, Great Falls, VA (US); Tyler MAIMAN, Melville, NY (US)

(73) Assignee: Capital One Services, LLC, McLean, VA (US)

(21) Appl. No.: 18/488,087

(22) Filed: Oct. 17, 2023

(51) Int. Cl. G06Q 20/40; G06Q 20/34

(52) U.S. Cl. CPC G06Q 20/409; G06Q 20/34

(57) ABSTRACT

A computer-implemented method may include: obtaining image data of a physical item, extracting, based on the image data, a portion of an account key and one or more of a plurality of items, identifying a custodian, transmitting at least one of the portion of the account key and the one or more of the plurality of items, and receiving a virtual certification number generated by the application programming interface based on the one of the portion of the account key and the one or more of the plurality of items and associated with the account.

### TECHNICAL FIELD

Various embodiments of the present disclosure relate generally to systems and methods for generating virtual certification numbers.

### BACKGROUND

Physical items, such as identification cards or payment cards, may be used in connection with digital devices to perform actions over a network. For example, a user of an e-commerce application on a mobile device may purchase goods or services using a physical payment card. Through the e-commerce application, the user may be prompted to capture an image of the payment card using a camera on the mobile device. The e-commerce application may then attempt to ascertain the information printed on the payment card, including the account number, by analyzing the image. Most frequently, optical character recognition (OCR) technology may be used to detect information printed on the payment card. OCR, however, may be unreliable and may be unable to detect the information. The user may then have to manually enter the information printed on the card into the e-commerce application to proceed with a transaction.

The present disclosure is directed to addressing the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for generating virtual certification numbers are described.

In one example, a computer-implemented method may include: obtaining, by an application accessible on a user device, image data of a physical item, wherein the physical item may be associated with an account and a custodian, and wherein the physical item may include an account key and a plurality of items of identifying information thereon; extracting, by the application based on the image data, a portion of the account key and one or more of the plurality of items, wherein the portion may be less than an entirety of the account key; identifying, by the application based on at least one of the portion of the account key and the one or more of the plurality of items, the custodian; transmitting, by the application to an application programming interface application programming interface associated with the custodian, at least one of the portion of the account key and the one or more of the plurality of items; and receiving, by the application from the application programming interface, a virtual certification number generated by the application programming interface based on the one of the portion of the account key and the one or more of the plurality of items and associated with the account.

In another example, a computer-implemented method may include: receiving, by an application programming interface from an application accessible on a user device, a request to authenticate the application, wherein the application programming interface may be associated with a custodian of a physical item associated with an account, wherein the physical item may include an account key and a plurality of items of identifying information thereon; authenticating, by the application programming interface, the application; receiving, by the application programming interface from the application, a portion of the account key and one or more of the plurality of items of identifying information, wherein the portion may be less than an entirety of the account key; identifying, by the application programming interface based on the portion of the account key and one or more of the plurality of items of identifying information, the account associated with the physical item; generating, by the application programming interface, a virtual certification number associated with the account; and transmitting, by the application programming interface to the application, the virtual certification number.

In a further example, a system may include: one or more memories storing instructions; and one or more processors operatively connected to the one or more memories. The one or more processors may be configured to execute the instructions to: obtain, via an application, image data of a physical item, wherein the physical item may be associated with an account and a custodian, and wherein the physical item may include an account key and a plurality of items of identifying information thereon; extract, via the application based on the image data, a portion of the account key and one or more of the plurality of items, wherein the portion may be less than an entirety of the account key; identify, via the application based on at least one of the portion of the account key and the one or more of the plurality of items, the custodian; transmit, by the application to an application programming interface associated with the custodian, at least one of the portion of the account key and the one or more of the plurality of items; receive, by the application from the application programming interface, a virtual certification number generated by the application programming interface based on the one of the portion of the account key and the one or more of the plurality of items and associated with the account; and transmit, by the application to a remote server, the virtual certification number.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts an exemplary physical item, according to one or more embodiments.

FIG. 3 depicts a flowchart of an exemplary method of obtaining a virtual certification number, according to one or more embodiments.

FIG. 4 depicts a flowchart of an exemplary method of generating a virtual certification number, according to one or more embodiments.

FIG. 5 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first user device could be termed a second user device, and, similarly, a second user device could be termed a first user device, without departing from the scope of the various described embodiments. The first user device and the second user device are both user devices, but they are not the same user device.

In general, the present disclosure is directed to systems and methods for generating, obtaining, and/or transmitting a virtual certification number. The methods and systems according to the present disclosure offer significant technical benefits which will become apparent. For example, aspects of the present disclosure may significantly improve a likelihood of successfully using a physical item with a digital device. Aspects of the present disclosure may also reduce a threshold image quality necessary for successful use of a physical item.

Physical items may be frequently used in connection with digital devices to perform actions over a network. Such physical items may include, for example, payment cards, government-issued identifications, insurance cards, identification tokens, badges, or the like. A digital device may scan a physical item to obtain information, and then use the information to perform a particular action. Scanning of the physical item may obviate a need for the user to manually input such information, thereby saving time and reducing a likelihood of human error.

As an example of how a physical item may be used in such a way, a user of an e-commerce application on a mobile device may attempt to purchase goods or services via the application using a physical payment card. During check-out, the e-commerce application may prompt the user to capture an image of the payment card using a camera on the mobile device as an alternative to requiring the user to manually enter the account information printed on the payment card. The e-commerce application may then attempt to ascertain the information printed on the payment card, including the account number, account holder name, expiration date, card verification value (CVV), and the like, by analyzing the image.

Frequently, optical character recognition (OCR) technology may be used to detect relevant information printed on a payment card. Use of OCR in this context, however, may require that every one of several items of information printed on a payment card be accurately detected. For example, a successful payment card transaction may require accurate detection of each digit of a sixteen-digit account number, each digit of a four-digit expiration date, each digit of a three or four-digit CVV, and/or each letter of an account holder's name. Failure to detect any one of the foregoing items may prevent the application from proceeding with the transaction. Accurate detection of the foregoing items may be inhibited by a variety of factors, such as physical wear on the payment card, environmental lighting and/or reflectivity of the payment card, resolution of the camera of the mobile device, steadiness of the user's hand, or the like.

Upon failure to detect one or more of the items of information on the physical card, the user may be required to manually enter the information printed on the card into the e-commerce application to proceed with a transaction. Manual entry may be time consuming and may introduce potential human error into the transaction process.

Accordingly, a need exists to address the foregoing challenges. Particularly, a need exists to improve image recognition for physical items and the usefulness of images captured of physical items. Embodiments of the present disclosure offer technical solutions to address the foregoing needs, as well as other needs.

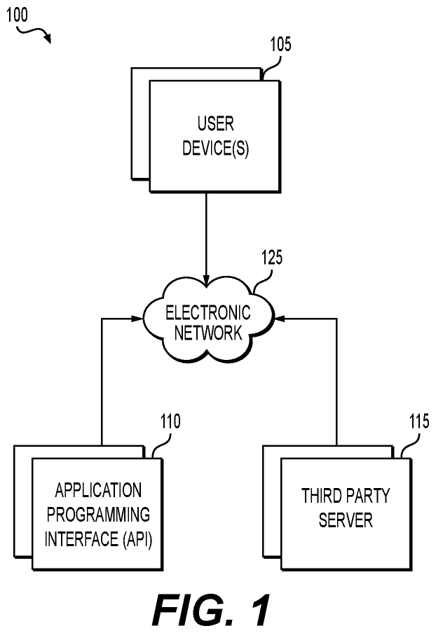

FIG. 1 depicts an exemplary computing environment 100 that may be utilized with techniques presented herein. One or more user device(s) 105, an application programming interface 110, and a third party server 115 may communicate across an electronic network 125. The user device 105 may be associated with, and used by, a user. The systems and devices of the computing environment 100 may communicate in any arrangement. As will be discussed herein, systems and/or devices of the computing environment 100 may communicate in order to generate, transmit, and/or obtain virtual certification numbers.

The user device 105 may be a computer system such as, for example, a desktop computer, a mobile device, etc. In an exemplary embodiment, the user device 105 may be a cellphone, a tablet, or the like. In some embodiments, the user device 105 may include one or more electronic application(s), e.g., a program, plugin, browser extension, etc., installed on a memory of the user device 105. In some embodiments, the electronic application(s) may be associated with one or more of the other components in the computing environment 100. For example, the electronic application(s) may include a web browser, another application, or the like configured to allow access to products or services offered by an entity associated with the third party server 115. In some embodiments, the electronic applications may include online shopping software associated with a merchant and/or a web browser configured to access such online shopping software. In some embodiments, the electronic applications may include applications associated with government services for which a user identity and/or account is required for access. In some embodiments, the electronic applications may include other types of applications and/or services for which a form of membership is required, such as social media applications, rewards clubs applications, insurance applications, library applications, streaming services, or the like.

Application programming interface 110 may be a computer system that facilitates communication between user device 105 and a computer system corresponding to and maintained by a custodian and/or issuer of a physical item. Application programming interface 110 may comprise one or more server devices and the one or more server devices may be located in one or more physical locations. For example, application programming interface 110 may exist within a cloud infrastructure supported by a plurality of server devices distributed across multiple geographical locations. Application programming interface 110 may allow an application running on user device 105 to communicate with data servers of a custodian or issuer of a physical item. For example, in a case where the application running on user device 105 is that of an e-commerce merchant, application programming interface 110 may allow the application to communicate with a financial institution that issues physical items, such as payment cards. Alternatively, for some other applications, application programming interface 110 may allow communication with a government entity that issues a physical item, such as an identification or a driver's license. In other embodiments, application programming interface 110 may facilitate communication with other entities, such as insurers, membership clubs, or the like. In some embodiments, application programming interface 110 may facilitate communication with multiple custodians and/or issuers of physical items. For example, application programming interface 110 may serve as an aggregator for communication with multiple financial institutions.

Third party server 115 may be a computer system for hosting, running, and/or maintaining applications and/or software accessible by user device 105. Third party server 115 may comprise one or more server devices and the one or more server devices may be located in one or more physical locations. For example, third party server 115 may exist within a cloud infrastructure supported by a plurality of server devices distributed across multiple geographical locations. In some embodiments, third party server 115 may host and/or support an e-commerce application accessible by user device 105. In some embodiments, third party server 115 may host and/or support other types of applications, such as insurance applications, government services applications, social media applications, rewards membership applications, and the like.

In various embodiments, the electronic network 125 may be a wide area network (“WAN”), a local area network (“LAN”), personal area network (“PAN”), or the like. In some embodiments, electronic network 125 may be a secured network. In some embodiments, the secured network may be protected by any of various encryption techniques. In some embodiments, electronic network 125 may include the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, the electronic network 125 includes or is in communication with a telecommunications network, e.g., a cellular network.

Although depicted as separate components in FIG. 1, it should be understood that a component or portion of a component may, in some embodiments, be integrated with or incorporated into one or more other components. Any suitable arrangement of the various systems and devices of the computing environment 100 may be used.

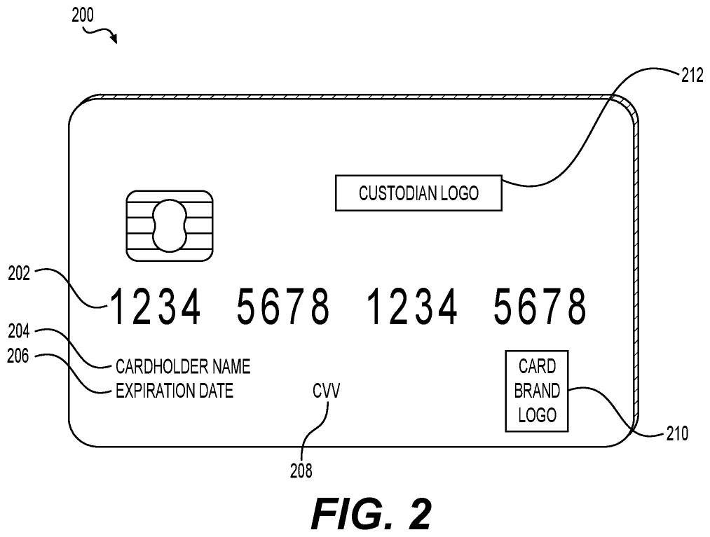

FIG. 2 illustrates an exemplary physical item 200 in accordance with the present disclosure. As shown in FIG. 2, exemplary physical item 200 may be a payment card such as a credit or debit card. It should be understood, however, that a physical item according to the present disclosure is not limited to such a payment card and may include other types of physical items such as government-issued identifications, insurance cards, identification tokens, badges, or the like. Indeed, the present disclosure may be relevant to any physical item on which items of identifying information are visible.

As shown in FIG. 2, physical item 200 may include an account key 202. In some embodiments, account key 202 may be a 16-digit numeric code as commonly found on credit and debit cards. In other embodiments, account key 202 may be an alphanumeric code of a different length, a bar code, a QR code, or any other suitable key and/or code. Exemplary physical item 200 may also include a cardholder name 204. Cardholder name 204 may be the name of the individual holding the account associated with the card. Exemplary physical item 200 may further include an expiration date 206 indicating a date until which the exemplary physical item 200 may be valid for use. Expiration date 206 may be in numerical format or alphanumerical format, for example. Exemplary physical item 200 may further include a card verification value (CVV) 208. CVV 208 may be a numerical value or any other suitable value. The items of identifying information on physical item 200 may be printed, etched, engraved, embossed, or otherwise included by any suitable means.

Additionally, physical item 200 may include one or more visual identifiers thereon. For example, where exemplary physical item 200 is a payment card, exemplary physical item 200 may include a card brand logo 210, such as Visa®, MasterCard®, Discover®, American Express®, or the like printed thereon. Exemplary physical item 200 may further include a custodian logo 212 printed thereon. For example, where physical item 200 is a payment card issued by a financial institution, custodian logo 212 may be a logo corresponding to the financial institution thereon. In some embodiments, custodian logo 212 may be a logo corresponding to an insurance carrier, a government entity, a membership club, or another type of issuer or custodian. In other embodiments, exemplary physical item 200 may include custom imagery printed thereon. Such custom imagery may include, for example, imagery representative of the user's favorite sports team, university, favorite animal, or any other such imagery.

Hereinafter, methods of using the computer environment 100 are described. In the methods described, various acts are described as performed or executed by one or more components shown in FIG. 1, such as user device 105, application programming interface 110, and/or third party server 115. However, it should be understood that in various embodiments, various components or combinations of components of the computing environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

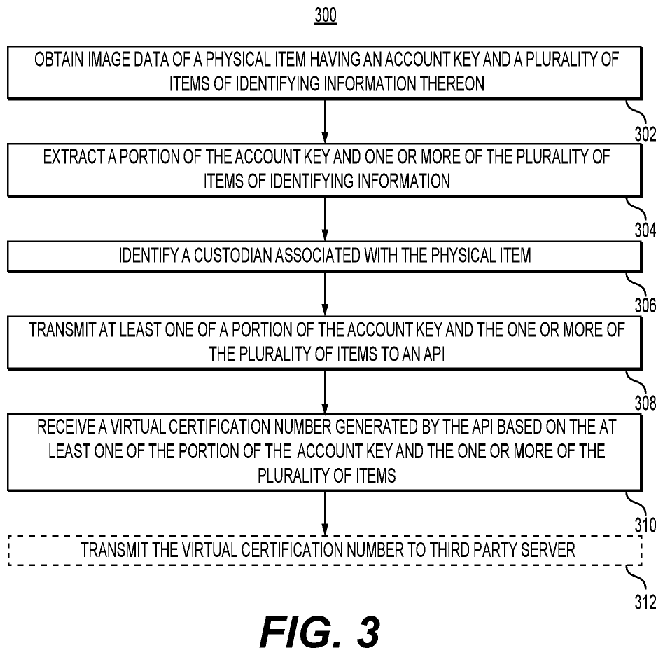

FIG. 3 depicts an exemplary process 300 of obtaining a virtual certification number, according to one or more embodiments. Process 300 may be performed when a user wishes to use physical item 200 with an application on user device 105. In some instances, process 300 may be performed when physical item 200 cannot be successfully scanned by ordinary techniques. It is to be understood that the process 300 may include fewer than all steps shown in FIG. 3 or may alternatively include additional steps not shown in FIG. 3.

At step 302, an application running on user device 105 may obtain image data of physical item 200. The application may prompt the user to display physical item 200 for a camera of user device 105 to obtain one or more images of physical item 200. In some embodiments, as described previously, the application may be an e-commerce application and physical item 200 may be a payment card with which the user wishes to make a purchase. Once the user has selected one or more goods to purchase, the user may proceed to a checkout screen and be prompted for payment information. In lieu of manually entering information appearing on physical item 200, the user may be prompted to present physical item 200 (e.g., a payment card) to a camera of user device 105. Image data of physical item 200 may then be generated using the camera of user device 105.

As described previously, physical item 200 may include an account key 202 and a plurality of items of identifying information thereon. Such identifying information may include account key 202, cardholder name 204, expiration date 206, CVV 208, card brand logo 210, custodian logo 212, and/or other information thereon, such as personalized graphics. In other embodiments where the physical item is other than a payment card, the plurality of items of identifying information may include other alphanumeric strings, symbols, or the like.

At step 304, the application running on user device 105 may extract a portion of account key 202 and one or more of the plurality of items of identifying information from the image data. The application may extract less than the entire account key 202 and fewer than all of the plurality of items of identifying information for a variety of reasons. For example, environmental lighting on the physical item may obscure certain portions thereof, the user's fingers may block certain portions of the physical item, the physical item may be damaged such that certain portions are illegible, or the like. The application may extract any portion of account key 202, such as some of the left-most digits or characters, some of the right-most digits or characters, a subset of the centrally-located digits or characters, and/or a combination thereof. The application may further extract some or all of cardholder name 204, expiration date 206, CVV 208, card brand logo 210, custodian logo 212, and/or portions thereof.

At step 306, the application may identify a custodian associated with physical item 200 based on the information extracted in step 304. Specifically, the application may identify the custodian based on the portion of account key 202 and one or more of the plurality of items of identifying information. In embodiments in which the physical item is a payment card, for example, the application may identify the custodian any number of ways. If the first six digits of account key 202 are extracted in step 304, even if the remaining ten digits are unable to be extracted, the application may be able to identify the custodian as the first six digits may be unique to that custodian. In the case of a payment card such as physical item 200, the custodian may be a particular financial institution. As another example, if fewer than all of the first six digits of account key 202 are extracted in step 304, but the application is also able to identify card brand logo 210, the application may be able to determine missing digits within the first six digits and identify the custodian. As still another example, if custodian logo 212 is extracted in step 304, the application may be able to identify the custodian based solely on custodian logo 212 or based on custodian logo 212 and one or more other items of identifying information.

At step 308, once the application has identified the custodian, the application may transmit the information extracted in step 304 to application programming interface 110 associated with the custodian. Specifically, the application may transmit the portion of the account key 202 and one or more of the plurality of items of identifying information that were extracted from the image data to application programming interface 110. In some embodiments, the application may transmit the image data to application programming interface 110. In some embodiments, the application may be pre-registered with, and authenticated by, application programming interface 110 so that information transmitted by the application to application programming interface 110 can be trusted.

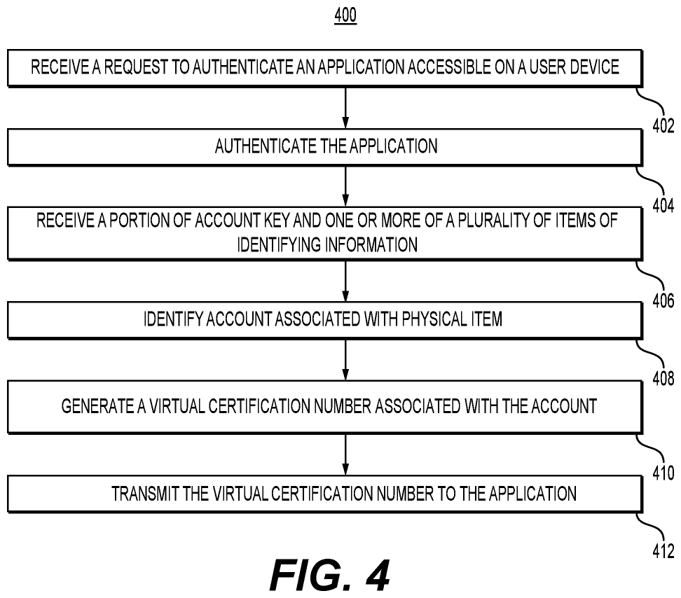

At step 310, the application may receive a virtual certification number from the application programming interface 110. The application programming interface 110 may generate the virtual certification number based on the portion of the account key 202 and the one or more of the plurality of items of identifying information extracted in step 304. Generation of the virtual certification number will be discussed hereinafter in greater detail with reference to FIG. 4 and process 400. In some embodiments, the virtual certification number may identify a virtual credit card or a virtual debit card.

In some embodiments, process 300 may continue to step 312. At step 312, the application may transmit the virtual certification number to third party server 115. For example, where the application is an e-commerce application and the user is attempting to purchase goods or services with physical item 200 (e.g. a payment card), the virtual certification number may be used in lieu of physical item 200 to proceed with the transaction. In some embodiments, the application may save the virtual certification as a default transaction for use in subsequent transactions or interactions. In some embodiments, the virtual certification number may be limited for use with the particular application such that it may not be used with other applications or merchants. Such a limitation may inhibit fraudulent use of the virtual certification number.

In some embodiments, prior to proceeding to step 304, the application and/or user device 105 may first attempt to detect account key 202 and/or other items of identifying information on physical item 200 by traditional means, such as OCR. If the application and/or user device 105 is able to successfully detect account key 202 and/or any other requisite items of identifying information on physical item 200 by OCR, process 300 may skip steps 304 through 310. If, however, the application and/or user device 105 is unable to successfully detect account key 202 and/or any other requisite items of identifying information on physical item 200 by OCR, the failure of OCR may trigger process 300 to proceed with step 304 and subsequent steps. For example, if the application is able to detect a portion of account key 202, but determines that a remainder of account key 202 cannot be detected, such a determination may trigger process 300 to proceed with step 304 and subsequent steps.

Process 300 may allow the user to perform a transaction with an account associated with physical item 200 even when not all of the information on physical item 200 may be extracted from image data by the application. When items of identifying information on physical item 200 are not able to be detected in their entireties, communication between the application and application programming interface 110 may allow for the generation of the virtual certification number, which may in effect act as a proxy for physical item 200. As a result, any need for the user to manually enter items of identifying information may be obviated. This may create a more convenient user experience and reduce a likelihood of human error introduce by manual data entry.

It is to be understood that process 300 need not necessarily be performed in the exact order described herein and the steps described herein may be rearranged in some embodiments. Further, in some embodiments fewer than all steps of process 300 may be performed and in some embodiments additional steps may be performed.

FIG. 4 depicts an exemplary process 400 of generating a virtual certification number corresponding to physical item 200 and transmitting it to an application running on user device 105 according to one or more embodiments. It is to be understood that the process 400 may include fewer than all steps shown in FIG. 4 or may alternatively include additional steps not shown in FIG. 4.

At step 402, application programming interface 110 may receive a request from an application accessible on user device 105 to authenticate the application. The application may request authentication, for example, to become a trusted application relative to application programming interface 110 and/or to access application programming interface 110.

At step 404, application programming interface 110 may authenticate the application. Application programming interface 110 may authenticate the application using any suitable authentication protocol, such as OAuth or the like. For example, an access token may be transmitted to the application as a result of the authentication and the access token may allow the application to access application programming interface 110. In some embodiments, the access token may be time limited. In other embodiments, an indication of the authentication may be transmitted to the application. In some embodiments, steps 402 and 404 may be performed significantly in advance of the remaining steps of process 400. For example, a large e-commerce platform with an associated application may wish for the application to become trusted by application programming interface 110, which may be associated with a large financial institution. In such instances, the e-commerce platform and the financial institution may expect to exchange information for a large number of users.

At step 406, once the application is authenticated, application programming interface 110 may receive a portion of account key 202 and one or more other of a plurality of items of identifying information on physical item 200. For example, as described previously with reference to FIG. 3, the application running on user device 105 may extract a portion of account key 202 and one or more of the plurality of items of identifying information from image data collected for physical item 200. The application may extract less than the entire account key 202 and fewer than all of the plurality of items of identifying information due to inadequate lighting on the physical item 200, obstruction of certain portions of physical item 200, damage to certain portions of physical item 200 rendering them illegible, or the like. The application may extract any portion of account key 202, such as some of the left-most digits, some of the right-most digits, and/or a combination thereof. The application may further extract some or all of cardholder name 204, expiration date 206, CVV 208, card brand logo 210, custodian logo 212, and/or portions thereof. The application may transmit any extracted items of identifying information to application programming interface 110. In some embodiments, the application may transmit image data of physical item 200 to application programming interface 110.

At step 408, application programming interface 110 may identify an account associated with physical item 200 based on the received portion of account key 202 and the one or more of the plurality of items of identifying information. Application programming interface 110 may identify the account associated with physical item 200 by comparing the received information against a database of accounts and information associated with the accounts. In some embodiments, application programming interface 110 may filter the database using the received information. For example, if application programming interface 110 receives a value of “John Smith” for cardholder name 204 and a value of “123” for CVV 208, application programming interface 110 may filter the database for accounts held by John Smith and having a CVV of 123. If application programming interface 110 identifies multiple accounts meeting those criteria, application programming interface 110 may continue to filter the account using any other identifying information received from the application. For example, application programming interface 110 may filter by any portion of account key 202 that was extracted, by expiration date 206, by card brand logo 210, by custodian logo 212, and/or any imagery appearing on physical item 200. If application programming interface 110 is able to narrow the field of accounts in the database using the information received from the application and match the received information to a single account, process 400 may proceed to step 410. If application programming interface 110 is unable to narrow the field of accounts in the database using the information received from the application to a single account, application programming interface 110 may return an error message to the application. In response, the application may instruct the user to manually input information for physical item 200.

In some embodiments, application programming interface 110 may further use the image data to filter the field of accounts. For example, application programming interface 110 may be able to detect whether unique imagery appears on physical item 200, and may filter the field of accounts to those associated with physical items with such imagery. In some embodiments, an absence of information and/or imagery on certain portions of physical item 200 may be used as a basis for filtering accounts. For example, a blank space on a predetermined portion of physical item 200 may identify physical item 200 as associated with a particular type of account. In some embodiments, the image data may be used and/or stored by application programming interface 110 to verify other items of identifying information or for security purposes.

At step 410, once application programming interface 110 has identified an account associated with physical item 200, application programming interface 110 may generate a virtual certification number associated with the account. The virtual certification number may serve as a proxy for physical item 200 and may allow the user to perform transactions with the account associated with physical item 200. In some embodiments, the virtual certification number may be limited for use within the application. In some embodiments, the virtual certification number may be limited for use within a certain time period.

At step 412, application programming interface 110 may transmit the virtual certification number to the application running on user device 105. The virtual certification number may then be used by the user and/or application to perform a transaction with the account associated with physical item 200. For example, user device 105 may transmit the virtual certification number to third party server 115 to perform the transaction.

It is to be understood that process 400 need not necessarily be performed in the exact order described herein and the steps described herein may be rearranged in some embodiments. Further, in some embodiments fewer than all steps of process 400 may be performed and in some embodiments additional steps may be performed.

Process 400, as described herein, may facilitate transactions by a user with an account associated with physical item 200. Due to the functionality of application programming interface 110, the user need not obtain a perfectly clear image of physical item 200. Instead, application programming interface 110 may be used to identify an account associated with physical item 200 based on identifying information that can be extracted from physical item 200, even if less than all information. Once the account associated with physical item 200 is identified, the virtual certification number may be generated and associated with the account to act as a proxy for physical item 200. This may obviate a need for the he user to manually enter items of identifying information printed on physical item 200 to perform a transaction with the account.

Moreover, generation of virtual certification numbers in the foregoing context and their use for transactions may present advantages over directly using physical items for transactions. For example, virtual certification numbers may be more secure than physical items as they may be limited for use with individual applications and/or merchants. Virtual certification numbers may also be ethereal in nature, meaning they may be generated without producing waste. Further, the availability of virtual certification numbers may reduce a likelihood of a user requesting a replacement physical card that is more easily scanned by a device.

Further aspects of the disclosure are discussed below. It should be understood that embodiments in this disclosure are exemplary only, and that other embodiments may include various combinations of features from other embodiments, as well as additional or fewer features.

In general, any process discussed in this disclosure that is understood to be computer-implementable or computer-implemented, such as the processes illustrated in FIGS. 3 and 4, may be performed by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system may include one or more computing devices. If the one or more processors of the computer system are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

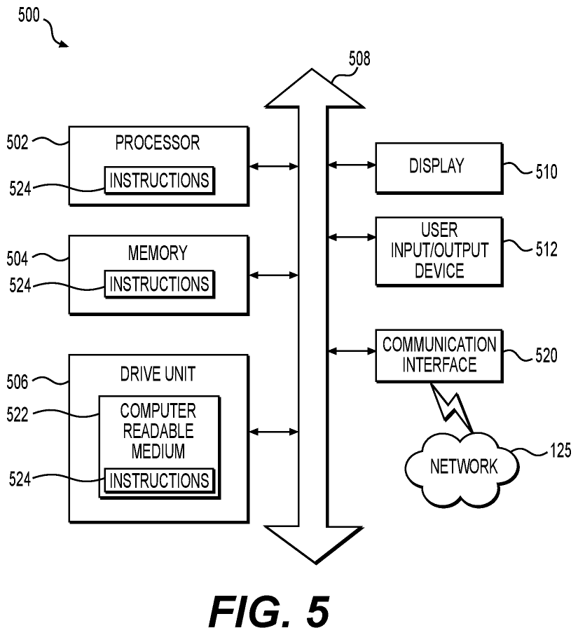

FIG. 5 is a simplified functional block diagram of a computer system 500 that may be configured as a device for executing the processes of FIGS. 3 and 4, according to exemplary embodiments of the present disclosure. FIG. 5 is a simplified functional block diagram of a computer that may be configured to serve as the user device 105, the application programming interface 110, and/or the custodian server 115, according to exemplary embodiments of the present disclosure. In various embodiments, any of the systems herein may be an assembly of hardware including, for example, a data communication interface 520 for packet data communication. The platform also may include a central processing unit (“CPU”) 502, in the form of one or more processors, for executing program instructions. The platform may include an internal communication bus 508, and a storage unit 506 (such as ROM, HDD, SDD, etc.) that may store data on a computer readable medium 522, although the system 500 may receive programming and data via network communications including via network 125. The system 500 may also have a memory 504 (such as RAM) storing instructions 524 for executing techniques presented herein, although the instructions 524 may be stored temporarily or permanently within other modules of system 500 (e.g., processor 502 and/or computer readable medium 522). The system 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to diagnosing a technology environment, it should be appreciated that the presently disclosed embodiments may be applicable to navigating and/or monitoring a technology environment for any other purpose.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the processes depicted in FIGS. 3 and 4, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method comprising:
obtaining, by an application accessible on a user device, image data of a physical item, wherein the physical item is associated with an account and a custodian, and wherein the physical item includes an account key and a plurality of items of identifying information thereon;
extracting, by the application based on the image data, a portion of the account key and one or more of the plurality of items, wherein the portion is less than an entirety of the account key;
identifying, by the application based on at least one of the portion of the account key and the one or more of the plurality of items, the custodian;
transmitting, by the application to an application programming interface application programming interface associated with the custodian, at least one of the portion of the account key and the one or more of the plurality of items; and
receiving, by the application from the application programming interface, a virtual certification number generated by the application programming interface based on the one of the portion of the account key and the one or more of the plurality of items and associated with the account.

2. The computer-implemented method of claim 1, further comprising:
transmitting, by the application to a remote server, the virtual certification number.

3. The computer-implemented method of claim 1, further comprising:
transmitting, by the application in response to identifying the custodian, a request to the application programming interface to authenticate the application; and
receiving, by the application from the application programming interface, an indication that the application is authenticated.

4. The computer-implemented method of claim 1, wherein the custodian is identified based on a first six characters of the account key.

5. The computer-implemented method of claim 1, wherein the plurality of items includes a logo corresponding to the custodian and wherein the custodian is identified based on the logo.

6. The computer-implemented method of claim 5, wherein the custodian is identified based on the logo and the portion of the account key.

7. The computer-implemented method of claim 1, further comprising:
determining, by the application, that a remainder of the account key cannot be extracted by optical character recognition (OCR); and
wherein identifying the custodian is triggered by the determining.

8. The computer-implemented method of claim 1, further comprising:
transmitting, by the application to the application programming interface, the image data;
wherein the virtual certification number is generated by the application programming interface further based on the image data.

9. The computer-implemented method of claim 1, wherein the one or more of the plurality of items includes an item verification value, an expiration date, or user name; and
wherein identifying the custodian is based on all of the portion of the account key and the plurality of items.

10. The computer-implemented method of claim 1, wherein the virtual certification number is limited for use with the application by the application programming interface.

11. The computer-implemented method of claim 9, further comprising:
saving, by the application, the virtual certification number as a default interaction method.

12. A computer-implemented method comprising:
receiving, by an application programming interface from an application accessible on a user device, a request to authenticate the application, wherein the application programming interface is associated with a custodian of a physical item associated with an account, wherein the physical item includes an account key and a plurality of items of identifying information thereon;
authenticating, by the application programming interface, the application;
receiving, by the application programming interface from the application, a portion of the account key and one or more of the plurality of items of identifying information, wherein the portion is less than an entirety of the account key;
identifying, by the application programming interface based on the portion of the account key and one or more of the plurality of items of identifying information, the account associated with the physical item;
generating, by the application programming interface, a virtual certification number associated with the account; and
transmitting, by the application programming interface to the application, the virtual certification number.

13. The method of claim 12, further comprising:
receiving, by the application programming interface from the application, image data for the physical item.

14. The method of claim 13, wherein identifying the account associated with the physical item is further based on the image data.

15. The method of claim 12, wherein the one or more of the plurality of items includes an item verification value, an expiration date, or user name.

16. The method of claim 12, wherein the one or more of the plurality of items further includes a logo.

17. The method of claim 12, further comprising:
limiting, by the application programming interface, the virtual certification number for use with the application.

18. The method of claim 12, wherein identifying the account associated with the physical item comprises:
accessing, by the application programming interface, a database of account information; and
matching the portion of the account key and one or more of the plurality of items of identifying information to a single account represented in the database.

19. The method of claim 12, wherein the one or more of the plurality of items of identifying information includes a blank space on a predetermined portion of the physical item.

20. A system comprising:
one or more memories storing instructions; and
one or more processors operatively connected to the one or more memories, the one or more processors configured to execute the instructions to:
obtain, via an application, image data of a physical item, wherein the physical item is associated with an account and a custodian, and wherein the physical item includes an account key and a plurality of items of identifying information thereon;
extract, via the application based on the image data, a portion of the account key and one or more of the plurality of items, wherein the portion is less than an entirety of the account key;
identify, via the application based on at least one of the portion of the account key and the one or more of the plurality of items, the custodian;
transmit, by the application to an application programming interface associated with the custodian, at least one of the portion of the account key and the one or more of the plurality of items;
receive, by the application from the application programming interface, a virtual certification number generated by the application programming interface based on the one of the portion of the account key and the one or more of the plurality of items and associated with the account; and
transmit, by the application to a remote server, the virtual certification number.
